(19) United States
(12) Patent Application Publication
(10) Pub. No.: US 2005/0129270 A1
(43) Pub. Date: Jun. 16, 2005

(54) Method and system for applying a watermark

(76) Inventor: Ravi Prakash, Concord, NC (US)

Correspondence Address: Hoffman, Warnick & D'Alessandro LLC, Three E-Comm Square, Albany, NY, 12207, US

(21) Appl. No.: 10/778,995

(22) Filed: Feb. 13, 2004

Related U.S. Application Data
(63) Continuation of application No. 09/652,281, filed on Aug. 30, 2000, now abandoned.

(51) Int. Cl. G06K 9/00; G06K 1/00; B41B 1/00

(52) U.S. Cl. 382/100; 382/137; 358/1.14

(57) ABSTRACT

A system and method of imaging a document wherein a watermark is created and applied to the image. The watermark includes identifying information and may include information to determine whether the image has been altered since its creation. In a system where a single document (such as a check) is used to create multiple images (in the case of a check, an image of the front and back may be created in different manners, such as with different resolution or different levels of grey-scale). The use of a single watermark for multiple images of the same check can be used to determine that the multiple images are in fact of a single document and not of different documents, either though mistake or deception. A digitized image of the document is stored and a watermark associated with the document is generated and overlaid on the image to create a watermark on the image of the document for later use and processing.

### CROSS REFERENCE TO RELATED PATENTS

The present invention is related to the following documents, each of which is assigned to the owner of the present patent application and is specifically incorporated herein by reference:

U.S. Pat. No. 4,888,812 issued to Dinan et al. entitled “Document Image Processing System”, a patent which is sometimes referred to in this document as the Check Image Patent.

patent application Ser. No. (tba —docket CHA9-99-017) filed concurrently by Rodney Gene Moon and Ravi Prakash and entitled “Method and System for Watermark Detection”, a document which is sometimes referred to in this document as the Watermark Detection Patent.

### BACKGROUND OF THE INVENTION

1. Field of the Invention

The present invention is an improved system and method for overlaying information on the image of a document. More particularly, the present invention includes a system for imaging a document and for adding an artificial “watermark” to the image.

2. Background Art

Checks are prepared in large quantities and represent “cash” to many in society today. Those checks are distributed for a variety of purposes—payroll, paying bills, purchasing goods and services, paying debts and dividends and interest. The volume of checks has been growing each year despite the rise of substitutes for cash, such as debit and credit cards, automatic teller machines, electronic funds transfers, automatic deposit of payments, automatic debits for bills and recurring transfers, electronic bill payment systems and other similar methods of conveying cash from one account to another.

As the number of checks increase, there is an increasing desire to process those checks quickly and efficiently, with a minimum of manual handling and a maximum application of automated processing techniques. Most checks are processed through the banking system (including both governmental central banking systems and commercial institutions including commercial banks and bank-like operations), where checks are processed in an automated fashion to extract the information, then forwarding document (or the information contained thereon) to other institutions as necessary for the collection of the check. Some check processing facilities receive in excess of one million items per day for processing. High speed check processing equipment (such as the IBM 3890 Document Processing System) have become common place for processing the checks in such facilities where large numbers of checks are received each business day. Many of the check sorting systems include an image capture device such as the ImagePlus High Performance Transaction System which IBM introduced in recent years to capture an image of the front and back of the check while it is being read and processed in the document processing system, between the time that the check is removed from a hopper at one end of the machine until it reaches a selected pocket at the other end of the machine. Such a system is described in the Check Image Patent referenced above.

As the number of checks increases, each check receives less and less manual attention and processing, relying on the automated equipment to do more of the processing. A check may have the account number and amount fee encoded on the check before the check is received and it may be provided with a tape listing of the amounts so that very little (if any) manual processing happens for each check in the banking system.

The increasing amount of automation and the decrease in manual processing along with an increase in sophisticated equipment for imitating a check opens the possibility for fraudulent activity in preparing and presenting checks. A criminal could take a genuine check and duplicate it (using techniques such as a photocopier), creating multiple similar checks or check blanks for fraudulent use or use a digital scanner to create a similar looking but totally bogus duplicate or blank check and use the bogus check improperly. Further, software for the creation of authentic-looking checks on a low-cost personal computer printer is widely available, complete with the appropriate magnetic ink character recognition symbols, checks which at one time were only available from large check printing companies using high-cost equipment. These examples illustrate that the spread of technology into low cost and widely-available hardware and software has made the production of fraudulent checks available at a nominal cost to those who need only a small investment and little, if any, technical expertise.

Since it is quick, easy and inexpensive to create fraudulent checks, it is not surprising that the number of such checks is increasing and has reached substantial proportions. It is accordingly a limitation of the prior art systems for processing checks that a simple, yet effective, way of detecting possibly fraudulent checks is not a part of the check processing systems. In a system where checks are imaged and the images are used for processing, it is possible that images would be altered or corrupted, either accidentally or deliberately. It is desirable to make such alterations difficult to accomplish or easy to detect an altered image.

Accordingly, it would be desirable to have a system which applies additional information to the image of a document, a sort of artificial watermark, so that the watermark may be used to detects whether the image of a check is authentic and/or whether the image has been altered. Such a system should be rather easy to use and allow for different watermarks to be on checks from different accounts. Such a system should also be difficult to fool with any alteration to the image of the check.

Various security measures are already in use in check processing. One of these is the use of microprinting of the signature line, which has the advantage that the printing becomes blurred when the microprinting is photocopied. The signature line printed using microprint technology creates a signature line which is discontinuous (having gaps smaller than the resolution of a photocopier or digital scanner) but which appears to the eye and to mechanical devices as a solid line. When a check with a microprint line is duplicated through a photocopied or a digital scanner, the line becomes solid, allowing differentiation of the original check (with a discontinuous microprint line) from the duplicated check (with a solid line).

Another technique for deterring the use of a photocopier to make a duplicate of a genuine check is the so-called “void pantograph”, a recurring printed pattern which, when produces a distinctive pattern of “VOID” legends across the check when photocopied but which is not apparent on the original check.

Various systems have been proposed for authenticating documents and images. One such system involves visually detecting a watermark which appears on an image and comparing the watermark to the watermark which is supposed to appear on the document. If the watermark is appropriate, then the document is presumed to be authentic and if the watermark is not present or has an incorrect appearance, then the document is suspect and presumed to be improper, perhaps because the document was prepared from a different paper stock than was authorized or perhaps because the document was altered at some point. In any case, to avoid a fraudulent transaction, the document would require careful attention—e.g., handling by hand rather than through an automated processing.

Many checks are processed at high speed through automatic processing systems known as document processors such as the IBM 3890 Document Processor. Such machines remove a single check from a stack of checks at an input hopper, move it along a pathway inside the processor past a read head which determines the particulars of the check (including the account and the amount) and then sorts the check into an appropriate pocket based on the information contained on the check. During the processing, the check may have information added to the check (such as an item number and/or an endorsement) and an image of the check may be captured, either through microfilming the check or through an image capture system using a digital camera.

Prior art watermark systems have other limitations and disadvantages which will be apparent to those skilled in the art in view of the following description of the present invention.

### SUMMARY OF THE INVENTION

The present invention overcomes the disadvantages and limitations of the prior art systems involving a watermark on an image of a document.

The present invention has the advantage that the authenticity of an image may be determined from the watermark on the image.

An other advantage of the present system is that the watermark may include information which will determine whether the image has been altered since the watermark was affixed.

A third advantage of the present invention is that the present invention includes a method and a system for creating a watermark on the image of a document which can be subsequently detected and processed.

The present invention is a system and method for providing and authenticating a watermark on a document created by imaging the document, overlaying a watermark on the document, then using the watermark for subsequent authentication of the image.

Other objects and advantages of the system and method of the present invention will be apparent to those skilled in the relevant art, in view of the following description of the preferred embodiment, taken together with the accompanying drawings and the appended claims.

### BRIEF DESCRIPTION OF THE DRAWINGS

Having thus described some of the objects and advantages of the present invention, other objects and advantages will be apparent to those skilled in the art in view of the following description of the invention taken in conjunction with the accompanying drawings in which:

FIG. 1 is a perspective view of a document processing system useful in practicing the present invention;

FIG. 2 is a view of a document including a watermark.

FIG. 3 is a view of a document with background information;

FIG. 4 is a view of a document including a watermark and background information;

FIG. 5 is a plot of the frequency distribution of the document of FIG. 4.

FIG. 6 is a flow chart of the process of the present invention.

### DETAILED DESCRIPTION OF THE PREFERRED EMBODIMENT

In the following description of the preferred embodiment, the best implementation of practicing the invention presently known to the inventor will be described with some particularity. However, this description is intended as a broad, general teaching of the concepts of the present invention using several specific embodiments but is not intended to be limiting the present invention to that as shown in these embodiments, especially since those skilled in the relevant art will recognize many variations and changes to the specific structure and operation shown and described with respect to these figures.

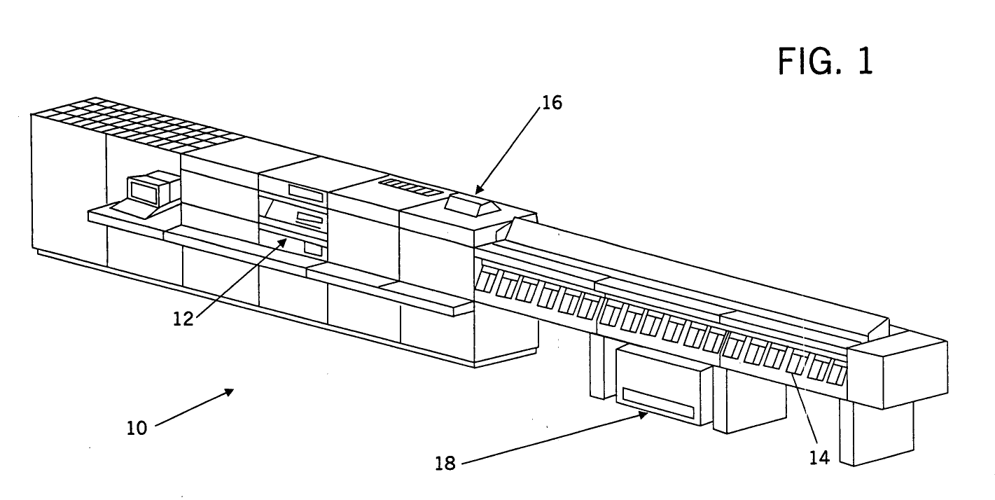

FIG. 1 illustrates a document processing system 10 of the type useful in processing documents including a watermark as described in connection with the present invention. The document processing system 10 in the preferred embodiment includes a system for moving documents from an input hopper 12 to one of several output pockets or bins 14, moving each document in sequence past internal components within the document processing system (not shown) which perform some combination of the following steps: read a portion of the document; lift and store an image of the document, perhaps both front and read, in either black and white or gray scale; analyze the portion of the read portion of the document according to a stored program to determine into which output bin to sort the document, print information on the document and microfilm the document. More details on an illustrative document processing system for the present invention is shown and described in the Check Image Patent.

In the case where the document is a check being processed by a system such as the IBM 3890 Document Processor with the ImagePlus High Performance Transaction System, the check includes a set of characters printed in magnetic ink character recognition (MICR) font on the front of the check and the system includes a MICR reader (typically using magnetic reading techniques common in the art to determine the printed numbers). Those printed numbers include the routing and transit codes, the account number and the amount as well as optionally a check number. The IBM system described about also lifts an image of the front and back of the document in each of black and white and gray scale for use in later processing of the image. The IBM system also includes a stored program which specifies into which of a plurality of pockets each document is to be sorted based on the MICR characters, allowing a bank to use conventional technology to put checks on that bank in one pocket, to put checks on other local bank(s) in other pocket(s) and checks going to distant banks in pocket(s) designated for sending to a collecting bank such as the Federal Reserve Bank, although the sorting and the designation of pockets is somewhat arbitrary and the document processing system could be used to advantage for other sorting functions such as taking checks on a single account and placing them in numeric sequence order.

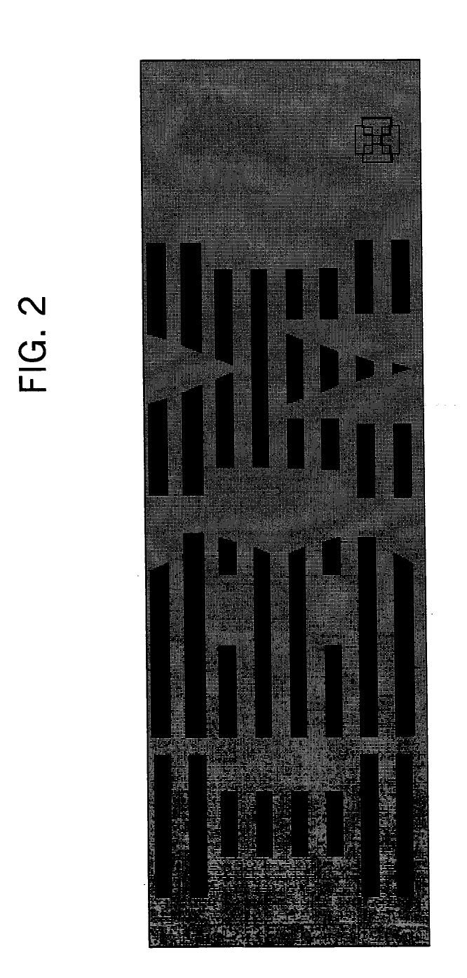

FIG. 2 illustrates an image of a document 20 with the appearance of a watermark 22 formed thereon. While it is possible to prepare the check on paper which has a watermark, it is also contemplated by the present invention that an image of a watermark could be applied to a document during the imaging process, that is, added electronically to the captured image obtained by passing the check through the document processing system 10 of FIG. 1 as described in the Check Image Patent referenced above.

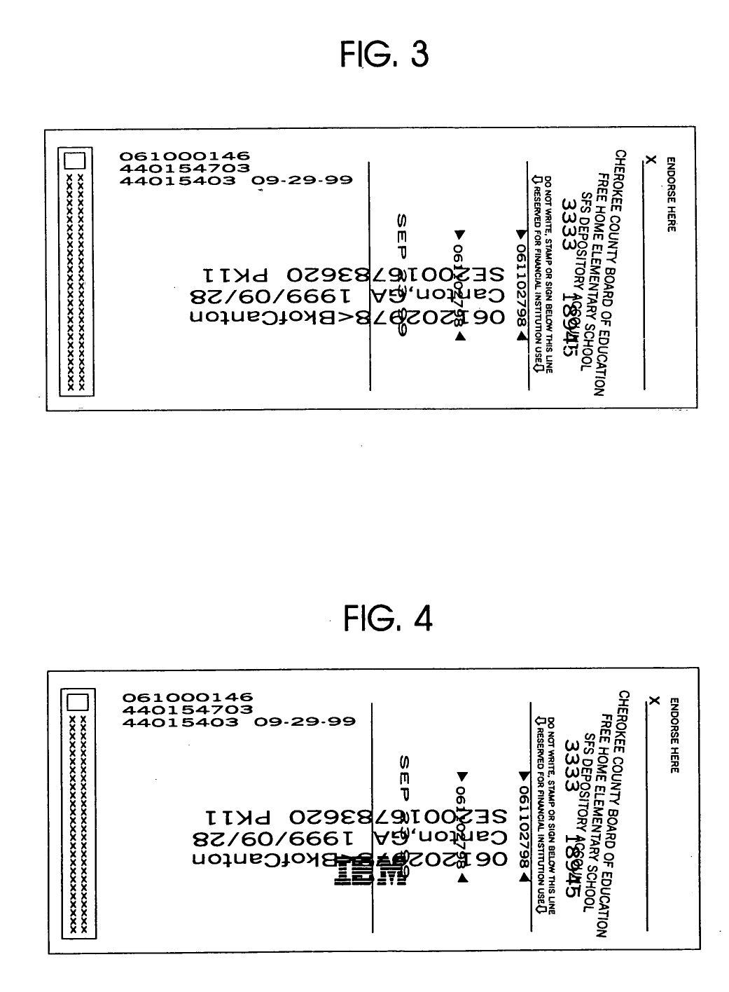

FIG. 3 is an image of a second document 30 (a different check) in which the document includes a printed background 32 in addition to the elements which are conventionally printed on the document including a MICR line 34 and other components of a check such as printed lines for the date, payee, amount fields and signature line. While the printed lines for the payee, amount fields and signature line as well as the MICR line tend to occupy a rather small portion of the document with a rather sharp black image, the printed backgrounds for documents such as checks tend to be more diverse, sometimes occupying much, if not all, of a side of the document and including various shades of color or gray. In short, documents with background present a diverse image with many pixels of shades of color, making imaging of the document difficult and have the potential for interfering with imaging equipment.

FIG. 4 shows an image 40 of a document with both a watermark 42 and a printed background of the type which is sometimes found on checks with scenic backgrounds.

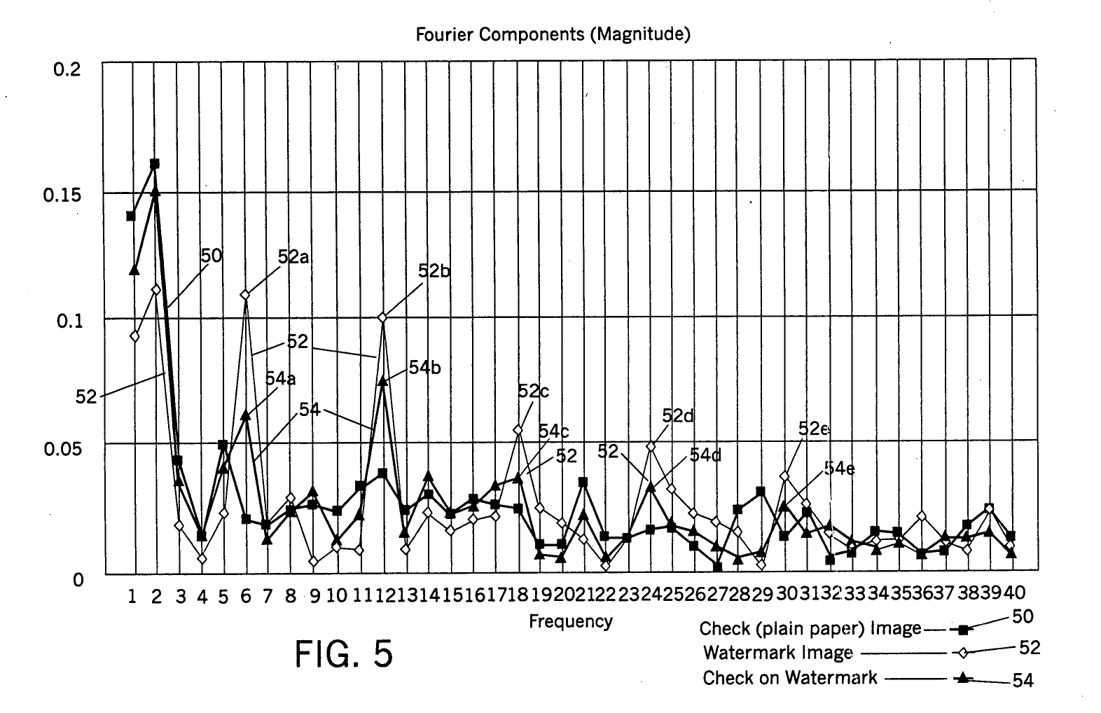

FIG. 5 is a view of three different frequency distributions from Fourier analysis on document images. As illustrated in this view, a first plot 50 (using square data points) illustrates a representative plot for a plain paper check image (without a watermark). A second plot 52 (using diamond data points) illustrates a representative plot for a watermark image. A third plot 54 (using triangular data points) illustrates a representative plot for the analysis of a check with a watermark. Each of the plots includes a plurality of relative maximums or peaks, and the location of these peaks determines whether there is a “beat” or harmonic pattern and at what frequency. The second plot 52 includes relative peaks at a frequency of 6 (data point 52a), 12 (data point 52b), 18 (data point 52c), 24 (data point 52d) and 30 (data point 52e). Similarly, the plot of the check plus watermark has relative peaks 54a, 54b, 54c, 54d and 54e at the corresponding frequency location. The first plot 50 of the plain check does not have such a pattern, with relative peaks occurring at almost random locations (for example, at frequency 5, 12, 21, 29 as shown in FIG. 5). While the second plot 52 and third plot 54 have a frequency distribution 50 includes a “beat” pattern which is the result of including the watermark, a beat pattern is not present in the first plot 50, the frequency distribution of the image without the watermark. Different watermarks have different frequency distributions and a harmonic or beat pattern at different frequencies. So, while the plots shown in FIG. 5 have a beat pattern at a frequency interval of 6, other watermarks may have a beat pattern at a lesser or greater frequency, but the beat pattern in the image of the check plus a watermark matches the beat pattern in the original watermark. Knowing the watermark of a particular watermark (and storing it in a table associated with the particular check, as indicated by its account number) then allows for images of checks which are supposed to bear that watermark to be validated. The validity of the image can therefore be verified by determining that the frequency of the beat pattern is the one which is expected as described in connection with the Watermark Detection Patent referenced above, and the beat pattern of the watermark comes through, even when the document includes other information.

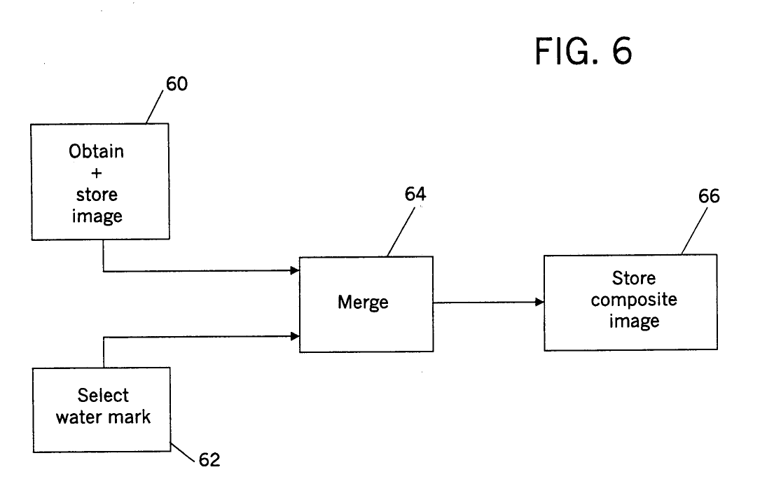

FIG. 6 is a flow chart of one method of practicing the present invention. The first step in the method is to obtain and store an image of the document using conventional equipment at block 60, a raw image such as comes from an image camera of the type included on the apparatus of FIG. 1. Then, a watermark image is selected at block 62 and overlaid on the image of the document in a merge process at block 64. The resulting image, which is the merger of the lifted image of the document and the selected watermark, is then processed as the image for the document through storage and/or other processing at block 66.

The watermark which is selected at block 62 may be based on the content of the document being processed or the processing equipment on which the document is processed. In its preferred embodiment, it includes fixed information (like a company name or its logo) and/or variable information (like the date and place of image capture as well as a sequence number).

Inclusion of a sequence number or other unique identifier has the advantageous effect that the same unique watermark may be applied to related images to insure that the images remain associated or that a mistake can be identified. Typically in the image processing of checks as described in the Check Image Patent and elsewhere in the industry, multiple images associated with the same document are captured and must remain associated together, For one example, the front and back of the same check are imaged at somewhat different times and by different cameras. It would be desirable that the image of the front and back of the same check be linked together by a device which insures that the correct front image is associated with the correct back image, and by including the date, processing machine and sequence number or other identifier which uniquely identifies the single document, it is possible to provide the front image with an identifier to the back image so that no other back image could be correctly associated with the front image. In the same manner, some image systems capture different views of the same image: images at different resolution in pixels per inch or images with different image characteristics (black/white or gray scale). It s desirable that all of the views of a single document be tied together with a single unchangeable identifier so that the views of a single document can be associated together and that a mistaken view can be identified as a mistake before it is relied upon.

The merge process of block 64 uses conventional image integration techniques such as superimposition. Once the images are integrated into a composite image it is difficult, if not impossible to separate or alter the watermark without destroying the image.

The present use of watermarks contemplates the use of both visible and invisible watermarks. That is, visible watermarks are apparent to the unaided eye while invisible watermarks are not apparent to the unaided eye but can be detected through the use of suitable equipment and processes such as are disclosed in the Watermark Detection Patent referenced above.

The present invention may be implemented in the a computer such as a general purpose processor with suitable software. It may also be implemented through the use of a specialized processor which is configured to do the processing described in connection with the previous description. The present invention can be realized, according to the designer's interests, in hardware, software, or a combination of hardware and software. An image processing system according to the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. Relevant portions of the present invention can also be embedded in one or more computer program products, which comprise at least selected portions of the features enabling the implementation of the methods described herein, and which—when loaded in a computer system—are able to carry out these methods.

As used in the present document, software, computer program and computer program means are used interchangeably. Software in the present context means any expression, in any language, code or notation, of a set of instructions intended to cause a system having an information processing capability to perform a particular function either directly or after either or both of the following a) conversion to another language, code or notation; b) reproduction in a different material form.

Of course, many modifications of the present invention will be apparent to those skilled in the relevant art in view of the foregoing description of the preferred embodiment, taken together with the accompanying drawings and the appended claims. For example, various watermarks could be used to advantage in the present invention. Additionally, some elements of the present invention can be used to advantage without the corresponding use of other elements. For example, use of the system described in the Watermark Detection Patent could be replaced with another system for detecting and verifying the watermark, such as a teller inspecting the image. Accordingly, the foregoing description of the preferred embodiment should be considered as merely illustrative of the principles of the present invention and not in limitation thereof.

1. A system for processing a document including data, the system comprising:
a system for capturing multiple images of the same document;
a system for generating a watermark associated with the document;
a merging apparatus for combining the watermark with more than one of the multiple images, whereby the multiple images each include a watermark associated with the document; and
storage for storing the combined images of the document with the watermark associated with the document.

2. The system of claim 1 wherein the system further includes a system for reading some of the data associated with the document, with the watermark including some of the data read from the document.

3. The system for processing images of the type described in claim 1 wherein the system further includes a first image camera for receiving and digitizing the front of the document creating a first image and a second image camera for receiving and digitizing the back of the document creating a second image, wherein the same watermark is applied to the first and second images.

4. The system for processing images of the type described in claim 3 wherein at least one of the first and second image cameras captures more than one image of the same document and the system for applying the watermark applies the same watermark to the more than one image by the at least one of the first and second image cameras.

5. The system for processing images of the type described in claim 1 wherein the system for applying watermarks applies a first watermark portion which is visible and a second watermark portion which is not visible.

6. A set of images associated with a document which has passed by at least one image camera, the set of images including a first image and a second image both associated with the document, said first and second images each including an added watermark which is unique to the document, whereby an image associated with the document can be differentiated from an image which is associated with another document.

7. A set of images of the type described in claim 6 wherein each of the images includes a visible watermark and an invisible watermark.

8. A set of images of the type described in claim 6 wherein each of the images includes a first watermark portion which has a company identity and a second watermark portion which includes variable information for that document.

9. A set of images of the type described in claim 8 wherein the variable information includes the date on which the image was processed.

10. A set of images of the type described in claim 8 wherein the variable information includes a unique sequence number associated with the document.

11. A set of images of the type described in claim 8 wherein the company identity is the identity of the company processing the document.

12. A method of processing a document comprising the steps of:
generating a first image of the document;
creating a watermark for the document
combining the image of the document with the created watermark to create a composite image of the document with the watermark; and
generating a second image of the document and applying a watermark to the second image which indicates its association with the first image and its watermark, whereby the first and second images from the same document may be associated together by virtue of the watermark applied to the first and second images.

13. The method of claim 12 further including the step of creating a watermark with a visible portion and an invisible portion.

14. The method of claim 12 further including the step of creating a watermark with a first common portion and a second unique portion, with the common portion being applied to different documents and the unique portion being applied only to images associated with a single document.

15. The method of claim 14 wherein the step of creating a watermark with a unique portion includes the step of including the date of processing in the watermark.

16. The method of claim 14 wherein the step of creating a watermark with a unique portion includes the step of including a sequence number in the watermark.

17. A method of preparing a set of images related to a single document, the steps of the method comprising:
using a camera to create multiple images of the same document;
creating a unique watermark for the document;
applying the same unique watermark to each of the multiple images of the same document, whereby the multiple images of a single document will be apparent from the watermark and images associated with a different document will be distinguishable from the images associated with a single document in that the different images will have differing watermarks.

18. A method including the steps of claim 17 wherein the step of applying the same unique watermark to each of the multiple images includes the step of including a sequence number in the watermark.

19. A method including the steps of claim 17 wherein the step of applying the same unique watermark to each of the multiple images includes the step of including the date of processing in the unique watermark.

20. A method including the steps of claim 17 wherein the step of applying a watermark includes the step of applying a visible watermark and an invisible watermark.
